(19) United States
(12) Patent Application Publication
(10) Pub. No.: US 2021/0292199 A1
(43) Pub. Date: Sep. 23, 2021

(54) Device and Method for Filtering and/or Purifying Liquid

(71) Applicant: BebrO B.V., Hoevelaken (NL)

(72) Inventor: Bart Van Den Berg, Hoevelaken (NL)

(21) Appl. No.: 17/265,719

(22) PCT Filed: Aug. 2, 2019
(86) PCT No.: PCT/NL2019/050509

§ 371 Date: Feb. 3, 2021

(30) Foreign Application Priority Data
Aug. 3, 2018 (NL) 2021419

(51) Int. Cl. C02F 3/08; C02F 3/28; C02F 3/10

(52) U.S. Cl. CPC C02F 3/082; C02F 3/085; C02F 2003/001; C02F 3/104; C02F 2301/026; C02F 3/2833

(57) ABSTRACT

The invention relates to a device and method for filtering and/or purifying liquid. The device comprises: an outer housing provided with at least one outer opening; an inner housing which encloses an inner chamber, wherein the inner housing is provided with an inner opening; a purification chamber which extends between the outer housing and the inner housing, wherein the at least one outer opening debouches in the purification chamber and wherein the purification chamber is provided with a carrier material on which a biological purification film can form for filtering and/or purifying water; and wherein a side wall of the inner housing which is adjacent to the purification chamber is provided with one or more fluid throughfeed openings, and wherein, during use of the device, a substantially vortex-like fluid flow path is formed in the purification chamber, between the at least one outer opening and the fluid throughfeed openings.

Known in practice are devices for filtering and/or purifying liquid, particularly (waste)water, wherein the carrier material is set into motion in a purification tank intended for the purpose.

A drawback of known devices with such a moving bed filter is that it is kept in motion by means of supplying (compressed) air, which requires a relatively large amount of energy.

EP 06 830 960 shows a device which has for its object to solve this problem. Use is for this purpose made of a tank which has a degree of filling of 70-100% carrier material and which has to be completely filled with liquid to be able to be operative. This is necessary in order to have the carrier material rotate about a central axis in cylindrical layers.

A drawback of the known device is that for a good operation it has to be completely filled with the liquid for purifying, whereby these devices are difficult to control. In addition, it is the case that starting and stopping these devices is difficult because they have to be completely filled.

A further drawback of the known devices is that the residence time of the liquid for purifying varies at the different locations in the purification tank, such as in the centre and close to the outer side of the tank, whereby optimal purification is not achieved.

The object of the invention is to provide an improved device for filtering and/or purifying liquid, which obviates or at least reduces the drawbacks of the known devices.

The invention provides for this purpose a device according to claim 1 for filtering and/or purifying liquid.

An advantage of the device according to the invention is that the formation of a vortex-like fluid flow path results in a better distribution of the residence time, whereby all supplied liquid for purifying has substantially the same residence time in the device.

It is noted that the terms fluid and liquid are used interchangeably at various points in the text and are thereby interchangeable from the viewpoint of the application.

With the vortex-like fluid flow path it is achieved that all fed in liquid travels the same path length and is thus purified in equal measure, whereby a consistent quality of purification is guaranteed. This cannot be achieved with the known device, wherein the liquid around the central axis has a (much) longer residence time than the liquid close to the side walls.

The vortex-like flow path in the device according to the invention further has the advantage that the formation of ‘short-cut flows’ is substantially prevented because an almost equal inward or outward directed (suction) force is exerted on all supplied liquid, whereby the formation of a shorter flow path is prevented.

Yet another advantage of the device according to the invention is that it is not required for the purification chamber to be completely filled with liquid (for purifying). This means that the device can be used across a wider range of supply quantities, without damage occurring to the device. A single device according to the invention can thereby be used both for supply flows with a relatively limited size and for supply flows with a greater quantity of liquid. This is not possible in the known device, because it has a fixed tank volume which must be precisely (completely) filled.

The inner and outer housing of the device according to the invention are preferably chosen such that they do not form any dead spaces where the liquid for purifying may remain behind. This further intensifies the vortex effect of the device.

A further advantage of the device according to the invention is that it is scalable and can in principle be manufactured in any length. This is caused by the fact that the relative placing of the at least one outer opening, the inner opening and the fluid throughfeed openings relative to each other determines the formation of the vortex-like flow, whereby the device is not dependent on the degree of filling. In other words, the placing of the outlet does not determine the formation of the flow pattern, as it does in the known device. This has the result that the length of the device is limited in order to be able to achieve the desired flow pattern.

Yet another advantage is that the discharge of the purified water is protected from becoming blocked by the application of the inner housing. In the known devices extensive measures have to be taken in order to prevent the suction action resulting in accumulation at and thereby blockage of the outlet by the carrier material. Because the inner housing has a relatively large diameter and is preferably provided with a plurality of fluid throughfeed openings, accumulation at and blockage of the outlet is substantially prevented.

In addition, the device according to the invention results in the advantage that a large effective purifying area is realized because the available quantity of carrier material is employed very effectively. This is achieved particularly through the fact that the liquid for purifying is guided through a large part of the carrier material during the residence time, whereby the degree of purification is increased.

It is noted that the device can be disposed both in a horizontal position relative to a bottom surface and in a vertical position relative to a bottom surface. It is the case for both orientations that the operating principle and the operation of the device provide the above stated advantages over the known devices.

In a preferred embodiment of the device the fluid flows from the at least one outer opening to the fluid throughfeed openings during use of the device.

The device according to the invention can be employed in two different methods of operation. The device is preferably used such that the fluid for purifying is supplied via the at least one outer opening, wherein it moves along the fluid flow path to the fluid throughfeed openings. The purified fluid is discharged via the throughfeed openings and the inner chamber through the inner opening. A suction force is here exerted on the fluid for purifying, wherein a centrifugal force is simultaneously exerted on the carrier material by the vortex-like movement.

Owing to the combined action of the suction force, the centrifugal force and (in addition) the force of gravity, all acting on the carrier material, the discharge of fluid, and particularly the fluid throughfeed openings, are prevented in simple manner from becoming blocked due to accumulation of carrier material. It is even possible by mutually adjusting the different forces to drive the carrier material in outward direction such that one or more (throughflow) layers of carrier material are formed in the device.

In an alternative embodiment of the device the fluid flows from the fluid throughfeed openings to the at least one outer opening during use of the device.

As described above, the device according to the invention can be employed in two different methods of operation. In an alternative operation the fluid for purifying is supplied via the inner opening and then carried via the fluid throughflow openings into the purification chamber, where it moves along an outward directed vortex-like fluid flow path to the at least one outer opening and is there discharged. In this operation the liquid for purifying is thus ‘pressed’ outward by the supply.

In an embodiment of the device the at least one outer opening can be positioned such that during use of the device the vortex-like fluid flow path is formed in the purification chamber.

Positioning the at least one outer opening such that the vortex-like fluid flow path is formed has the advantage that no additional energy need be supplied in order to maintain the purification process. The operation of the purification process is thereby substantially determined by the supply of fluid through the at least one outer opening.

It must be noted here that the supply of fluid through the at least one outer opening can be controlled such that the combined action, already described above, of the suction force, the centrifugal force and (in addition) the force of gravity on the carrier material prevents the outlet for the fluid, and particularly the fluid throughfeed openings, from becoming blocked due to accumulation of carrier material.

It is possible, also by controlling the supply, such as the speed, intensity, quantity and supply location of the supply, to adjust the different forces on the carrier material to each other so as to drive the carrier material in outward direction (so away from the immediate vicinity of the fluid throughfeed openings) and thereby form one or more layers of carrier material in the device.

In an embodiment of the device the inner housing and/or the outer housing can be arranged rotatably around the longitudinal axis, wherein during use of the device the vortex-like fluid flow path in the purification chamber is formed by the rotation of the inner housing and/or the outer housing.

Arranging the inner housing and/or the outer housing rotatably enables the speed and the intensity and the flow properties of the flowing fluid, and with this the formation of the vortex-like fluid flow path, to be controlled in relatively accurate manner A high degree of reliability and controllability is hereby achieved.

Arranging the housing rotatably enables the different forces acting on the carrier material, and in particular the suction force, centrifugal force and the force of gravity, to be balanced in accurate manner in order to realize a (further) improved purification. The rotation is preferably chosen such that the carrier material is driven sufficiently in outward direction to form one or more layers of carrier material in the device.

In an embodiment of the device, the device can further be provided with a drive configured to drive the inner housing and/or outer housing.

A drive is preferably provided for the purpose of driving the inner and/or the outer housing which is controllable, so that the rotation speed of the inner and/or outer housing is controllable.

In an embodiment of the device the outer housing and the inner housing can be substantially cylindrical, wherein the inner housing has an inner housing diameter Dᵢₙ and the outer housing has an outer housing diameter Dₒᵤₜ, wherein Dₒᵤₜ>Dᵢₙ and wherein Dₒᵤₜ:Dᵢₙ preferably lies in the range of 2:1 to 1.75:1.

An advantage of dimensioning the housings in the above stated ratios is that the volume of the inner chamber is great enough to provide for a good discharge or supply of fluid, while at the same time a sufficiently great purification chamber is realized to realize an effective purification.

By making the diameter Dᵢₙ relatively great relative to the diameter Dₒᵤₜ the volume of the purification chamber is reduced, whereby the capacity decreases. Conversely, it is however the case that a greater diameter Dᵢₙ at the same time also results in a considerable reduction of the risk of accumulation of carrier material at and possible blockages of the fluid throughfeed openings, which are configured to discharge the purified fluid. In other words, with the above stated preferred range an optimal ratio is realized between the volume of the purification chamber and the risk of accumulation of carrier material around or close to the fluid throughfeed openings.

It is however noted that other ratios, ratios in both a greater and a smaller range, are also possible. It is here for instance possible to envisage Dₒᵤₜ:Dᵢₙ in the range of 4:1 or greater still, or conversely Dₒᵤₜ:Dᵢₙ in the range of 1.25:1.

In a preferred embodiment of the device the outer housing and the inner housing can be cylindrical and extend concentrically relative to each other about a longitudinal axis over a length.

An advantage of two concentric cylinders is that a substantially consistently formed purification chamber is formed, in which the necessary vortex-like flow can be realized in relatively simple manner These forms also have the advantage that they have a favourable volume compared to other forms.

A further advantage is that a device according to the invention which is formed from concentric cylinders can be easily extended by connecting additional cylinders to one of the outer ends. A modular device is thereby provided.

In an embodiment of the device the inner opening can be positioned close to a longitudinal axis of the inner housing, wherein the inner opening is preferably positioned at the position of the longitudinal axis of the inner housing.

An advantage of placing the inner opening centrally (in the outer end wall of the inner chamber) is that a consistent flow profile results in the inner chamber. A further advantage is that such a positioning has the advantage that it can be easily arranged during manufacture.

In an embodiment of the device the carrier material can comprise a composition of carrier material, wherein the carrier material is chosen from a group of carrier material which floats on water, carrier material which sinks in water or a mixture of carrier material which floats in water and carrier material which sinks in water.

The carrier material in the device can be embodied in diverse ways and in diverse forms with known carrier material. The carrier material composition is however preferably chosen as a mixture of carrier material which floats in water and carrier material which sinks in water. In combination with the device, such a composition has the advantage that a better radial distribution of the carrier material in the device is realized. Due to the greater centrifugal force thereon the heavier, sinking carrier material will position itself during use of the device radially outward from the lighter, floating carrier material, whereby a uniform distribution of the carrier material in the fluid flow path results. In other words, different layers of carrier material are formed in the device, wherein the different layers are preferably also provided with different types of bacteria so as to form different ‘purification zones’. An improved purification efficiency is hereby achieved.

A further advantage is that gas which is present in the purification chamber or is supplied into the chamber is subject to a suction force greater than the opposing centrifugal force, whereby the gas is transported inward and, in some cases, forms an ‘air gas’ in or close to the centre of the device (in the inner chamber and/or in the purification chamber).

In an embodiment of the device the outer housing can have a length, wherein the at least one outer opening extends substantially over the whole length of the outer housing.

An advantage of this embodiment is that a consistent and well-distributed fluid flow path forms, along which the liquid for purifying is carried. The formation of ‘dead spaces’ is hereby prevented still further.

In an embodiment of the device the outer housing and the inner housing can be provided with end walls, wherein the end walls are preferably provided with seals for sealing the inner housing and the outer housing, relative to each other and to the area surrounding the device, at the position of the end walls.

The outer housing and the inner housing are provided with end walls which bound and seal the purification chamber and/or the inner chamber. It is possible here to choose one integral seal and end wall of both the inner housing and the outer housing. This has the advantage that a simpler construction can be realized, whereby the manufacturing costs are lower. It is however also possible to choose two mutually connecting end walls with a seal, wherein the inner housing has an end wall and the outer housing has an end wall connecting thereto, wherein the end walls are also sealed relative to each other. This is advantageous, among other situations, when a rotating housing is applied.

In an embodiment of the device, the device can further be provided with a gas inlet for supplying reaction gas to the purification chamber, wherein the gas inlet is preferably positioned on an upper side of the outer housing, and wherein the purification chamber is preferably filled at least partially with a gas.

An advantage of applying a gas inlet is that additional gas, such as air, oxygen or nitrogen, can be supplied to the purification process in order to achieve an improved result or to realize a determined type of purification process. Nitrogen can thus for instance be used for denitrification of the supplied water.

An advantage of placing the gas inlet on the upper side of the outer housing is that no additional pressure need be exerted on the supply and that use can optionally even be made of an open feed from outside. A part on the upper side of the purification chamber is preferably not filled with liquid, but conversely with gas. Hereby, a better mixing is achieved and application of a filter or non-return valve becomes unnecessary. This results thereby in a more efficient process and, at the same time, a cheaper device.

It is of course the case that, when the device is placed under the waterline, the gas inlet is however preferably held under pressure.

In an embodiment of the device, the device can be provided with a control for controlling one or more of a supply speed of fluid for purifying through the inner opening and/or a rotation speed of the outer housing and/or the inner housing and/or a discharge speed of the purified water and/or a supply quantity of reaction gas to the purification chamber and/or a pressure in the purification chamber and/or the fluid discharge space by controlling the fluid infeed and/or the fluid discharge.

By controlling one or more of the above stated aspects with a control intended for the purpose a further process optimization and control can be achieved with the device according to the invention.

In an embodiment of the device a fluid level of the fluid in the purification chamber can be such during use of the device that the inner chamber is completely filled with fluid, wherein the fluid level is preferably such that the purification chamber is not completely filled with fluid.

An advantage of the device according to the invention is that only the inner chamber has to be completely filled, or has to be below the liquid level, for a good operation of the device. This makes completely filling the device unnecessary, whereby it also becomes possible to keep the device operative with smaller quantities of fluid supply, without negative effects on the biological population. It is preferably even the case that the fluid level in the purification chamber is kept below the maximum (i.e. 100% filled) in order to bring about a good purification.

It is also possible to choose a filling of around 100% in order to obtain a greater rotation speed, so that the risk of accumulation at the discharge grating is reduced still further.

The invention also relates to a method according to claim 14 for purifying and/or filtering liquid.

The method according to the invention has similar effects and advantages to the device according to the invention. The method according to the invention has the advantage that substantially all liquid for purifying travels the same length of fluid flow path in the device, whereby a consistent purification takes place and a constant quality of purified fluid is achieved.

In addition, the method has the advantage that a wide range of supply quantities can be accepted in the process without adjustments being necessary for this purpose. This means that both greater and smaller supply flows can be processed with the method according to the invention, whereas this is not possible with existing methods.

In a preferred embodiment of the method it comprises of the fluid flowing from the at least one outer opening to the fluid throughfeed openings.

The method according to the invention can be applied in two different ways. In a first way it comprises of supplying fluid for purifying via the at least one outer opening, wherein it moves along the fluid flow path to the fluid throughfeed openings. The purified fluid is discharged via the throughfeed openings and the inner chamber through the inner opening. A suction force is thus exerted here on the fluid for purifying.

In an alternative embodiment of the method it comprises of the fluid flowing from the fluid throughfeed openings to the at least one outer opening.

As described above, the method according to the invention can be applied in two different ways. In an alternative way the method comprises of supplying the fluid for purifying via the inner opening and then carrying it via the fluid throughfeed openings into the purification chamber, where it moves along an outward directed vortex-like fluid flow path to the at least one outer opening and is there discharged. In this operation the fluid for purifying is thus ‘pressed’ outward by the supply.

In an embodiment of the method according to the invention the method can further comprise of positioning and/or controlling the at least one outer opening so as to form the vortex-like fluid flow path in the purification chamber.

The advantage of this embodiment is that no additional energy need be supplied in order to maintain the purification process, whereby the method is more energy-efficient than the known methods.

In an embodiment of the method according to the invention the method can further comprise of rotation of the inner housing and/or the outer housing in order to form the vortex-like fluid flow path in the purification chamber.

The advantage of this embodiment according to the method is that the speed and the intensity of the flowing fluid, and with this the formation of the vortex-like fluid flow path, can be controlled in relatively accurate manner A high degree of reliability and controllability is hereby achieved.

In a currently preferred embodiment the method according to the invention for realizing the substantially vortex-like fluid flow path for the fluid comprises the steps of:
supplying the fluid for purifying via the at least one outer opening to the purification chamber and bringing it into contact with the carrier material;
realizing the vortex-like fluid flow path by supplying fluid for purifying to the purification chamber and rotating the inner housing and/or the outer housing, such that during the residence time in the purification chamber the supplied fluid is carried in ever-decreasing circles to the inner side of the purification chamber; and
flowing on the inner side of the purification chamber through fluid throughfeed openings to the inner chamber, after which the fluid is discharged as purified fluid.

The above stated steps are preferably combined with one or more of the steps also described above, more preferably when a carrier material composition is applied which comprises a mixture of floating carrier material and non-floating carrier material, in particular preferably in the following ratios described for the carrier material composition.

The invention also relates to a carrier material composition configured for use in a device according to the invention, wherein the composition comprises a mixture of floating carrier material and non-floating carrier material, wherein the ratio of floating carrier material and non-floating carrier material lies in the range of 70%-30% and more preferably about 50%-50%.

The carrier material composition according to the invention has similar effects and advantages as the device and the method according to the invention.

The carrier material can be embodied in the device in diverse ways and in diverse forms with known carrier material. The carrier material composition is however preferably chosen specifically for the device, wherein the composition is a mixture of carrier material which floats in water and carrier material which sinks in water. In combination with the device, such a composition has the advantage that a better radial distribution of the carrier material in the device is realized. During use of the device the heavier, sinking carrier material will position itself radially outward from the lighter, floating carrier material, whereby a uniform distribution of the carrier material in the fluid flow path results and, if desired, different purification layers can also be realized, which can also be provided with different types of bacteria. An improved purification efficiency is hereby achieved.

Further advantages, features and details of the invention are elucidated on the basis of preferred embodiments thereof, wherein reference is made to the accompanying drawings, in which:

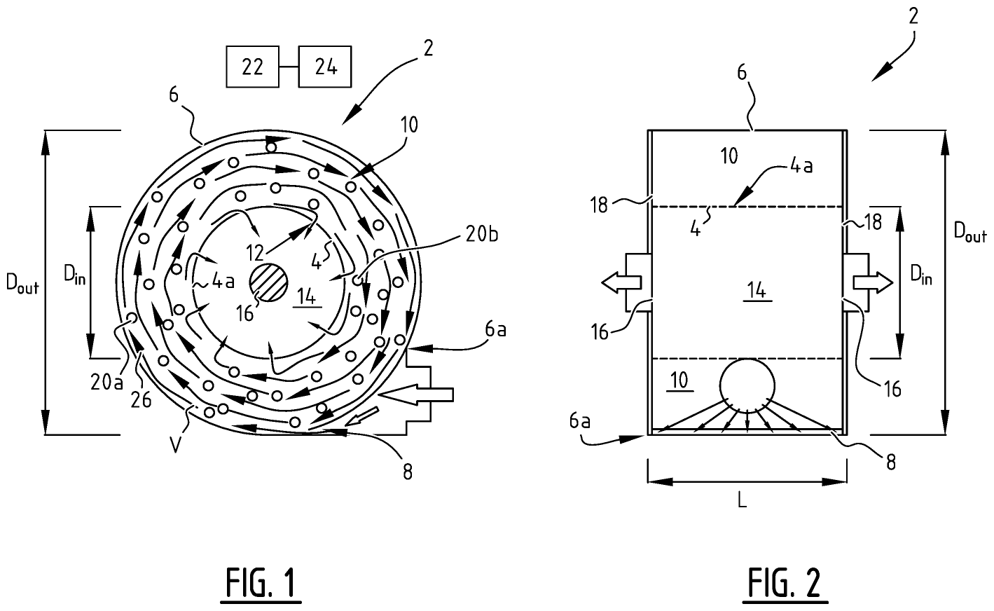

FIG. 1 is a schematic cross-section of an embodiment of a device according to the invention; and

FIG. 2 is a schematic cross-section of the embodiment of FIG. 1 parallel to the longitudinal axis.

In an embodiment of device 2 according to the invention it is provided with inner housing 4 and outer housing 6, each having a length L. Outer housing 6 has diameter Dₒᵤₜ and inner housing 4 has diameter Dᵢₙ. As can be clearly seen in FIG. 1, diameter Dₒᵤₜ is greater than diameter Dᵢₙ, whereby in this embodiment the surface area of inner housing 4 amounts to about 25% of the surface area of outer housing 6. Outer housing 6 is provided with outer opening 8, which in this embodiment extends over the whole length L of outer housing 6 and is provided on an outer side 6a thereof (see FIG. 2). Outer opening 8 is relatively small relative to diameter Dₒᵤₜ of outer housing 6.

Inner housing 4 and outer housing 6 collectively form purification chamber 10 which extends between the two housings 4, 6. Side wall 4a of inner housing 4 is provided with a plurality of fluid throughfeed openings 12 which are used in this embodiment to carry the fluid flow to inner chamber 14 which is enclosed by side wall 4a of inner housing 4. Inner housing 4 is further provided with inner openings 16 which are arranged in side wall 18 of inner chamber 4 and which debouch in inner chamber 14.

Purification chamber 10 is provided with carrier material 20, here formed from a mixture of carrier material 20a which sinks in water and carrier material 20b which floats in water. Further shown in this embodiment is optional drive shaft 22, with likewise optional drive 24 connected thereto.

In use of device 2 the fluid for purifying is supplied via outer opening 8 to purification chamber 10, in which it comes into contact with carrier material 20a, 20b and the biological material 26 decomposes and/or absorbs contamination in the water. The supply and/or the optional drive shaft which drives inner housing 4 realizes a vortex-like flow V in purification chamber 10. This ensures that during the residence time the supplied water is carried in ever-decreasing circles to the inner side of purification chamber 10 and there flows through fluid throughfeed openings 12 in side wall 4a to inner chamber 14, after which it is discharged via inner openings 16 from device 2 as purified liquid.

Alternatively, the flow direction V in device 2 is reversed, whereby vortex-like flow V is directed from inside to outside.

The present invention is by no means limited to the above described preferred embodiments thereof. The rights sought are defined by the following claims, within the scope of which many modifications can be envisaged.

1. A device for filtering and/or purifying liquid, the device comprising:
an outer housing provided with at least one outer opening;
an inner housing which encloses an inner chamber, wherein the inner housing is provided with an inner opening;
a purification chamber which extends between the outer housing and the inner housing, wherein the at least one outer opening debouches in the purification chamber and wherein the purification chamber is provided with a carrier material on which a biological purification film can form for filtering and/or purifying water; and
wherein a side wall of the inner housing which is adjacent to the purification chamber is provided with one or more fluid throughfeed openings, and
wherein, during use of the device, a substantially vortex-like fluid flow path is formed in the purification chamber, between the at least one outer opening and the fluid throughfeed openings.

2. The device according to claim 1, wherein the at least one outer opening is positioned such that, during use of the device, the vortex-like fluid flow path is formed in the purification chamber.

3. The device according to claim 1, wherein the inner housing and/or the outer housing are arranged rotatably around the longitudinal axis and wherein, during use of the device, the vortex-like fluid flow path in the purification chamber is formed by the rotation of the inner housing and/or the outer housing.

4. The device according to claim 3, wherein the device is further provided with a drive configured to drive the inner housing and/or outer housing.

5. The device according to claim 1, wherein the outer housing and the inner housing are substantially cylindrical, wherein the inner housing has an inner housing diameter Dᵢₙ and the outer housing has an outer housing diameter Dₒᵤₜ, wherein Dₒᵤₜ>Dᵢₙ, and wherein Dout:Din preferably lies in the range of 2:1 to 1.75:1.

6. The device according to claim 1, wherein the outer housing and the inner housing are cylindrical and extend concentrically relative to each other about a longitudinal axis over a length.

7. The device according to claim 1, wherein the inner opening is positioned close to a longitudinal axis of the inner housing and wherein the inner opening is preferably positioned at the position of the longitudinal axis of the inner housing.

8. The device according to claim 1, wherein the inner housing is provided with a plurality of fluid throughfeed openings.

9. The device according to claim 1, wherein the carrier material comprises a composition of carrier material, wherein the carrier material is chosen from a group of:
carrier material which floats on water;
carrier material which sinks in water; or
a mixture of carrier material which floats in water and carrier material which sinks in water.

10. The device according to claim 1, wherein the outer housing has a length and wherein the at least one outer opening extends substantially over the whole length of the outer housing.

11. The device according to claim 1, wherein the device is further provided with a gas inlet for supplying reaction gas to the purification chamber, wherein the gas inlet is preferably positioned on an upper side of the outer housing, and wherein the purification chamber is preferably filled at least partially with a gas.

12. The device according to claim 1, wherein the device is provided with a control for controlling one or more of:
a supply speed of fluid for purifying through the inner opening;
a rotation speed of the outer housing and/or the inner housing;
a discharge speed of the purified water;
a supply quantity of reaction gas to the purification chamber;
a pressure in the purification chamber and/or the fluid discharge space by controlling the fluid infeed and/or the fluid discharge.

13. The device according to claim 1, wherein a fluid level of the fluid in the purification chamber is such during use of the device that the inner chamber is completely filled with fluid, and wherein the fluid level is preferably such that the purification chamber is not completely filled with fluid.

14. A method for purifying and/or filtering liquid, the method comprising the steps of:
providing a device according to any one of the foregoing claims;
arranging carrier material in the purification chamber, wherein the carrier material is preferably provided with a biofilm;
supplying a fluid for purifying; and
realizing in the purification chamber a substantially vortex-like fluid flow path for the fluid which extends between the at least one outer opening and the fluid throughfeed openings.

15. The method according to claim 13, the method further comprising of positioning and/or controlling the at least one outer opening so as to form the vortex-like fluid flow path in the purification chamber.

16. The method according to claim 14, wherein the method further comprises of rotation of the inner housing and/or the outer housing in order to form the vortex-like fluid flow path in the purification chamber.

17. The method according to claim 14, wherein a fluid level of the fluid in the purification chamber is such during use of the device that the inner chamber is completely filled with fluid, and wherein the fluid level is preferably such that the purification chamber is not completely filled with fluid.

18. The method according to claim 14, wherein realizing the substantially vortex-like fluid flow path for the fluid comprises of:
supplying the fluid for purifying via the at least one outer opening to the purification chamber and bringing it into contact with the carrier material;
realizing the vortex-like fluid flow path by supplying fluid for purifying to the purification chamber and rotating the inner housing and/or the outer housing, such that during the residence time in the purification chamber the supplied fluid is carried in ever-decreasing circles to the inner side of the purification chamber; and
flowing on the inner side of the purification chamber through fluid throughfeed openings to the inner chamber, after which the fluid is discharged as purified fluid.

19. A carrier material composition configured for use in a device for filtering and/or purifying liquid, the device comprising:
an outer housing provided with at least one outer opening;
an inner housing which encloses an inner chamber, wherein the inner housing is provided with an inner opening; and
a purification chamber which extends between the outer housing and the inner housing, wherein the at least one outer opening debouches in the purification chamber and wherein the purification chamber is provided with a carrier material on which a biological purification film can form for filtering and/or purifying water,
wherein a side wall of the inner housing which is adjacent to the purification chamber is provided with one or more fluid throughfeed openings,
wherein, during use of the device, a substantially vortex-like fluid flow path is formed in the purification chamber, between the at least one outer opening and the fluid throughfeed openings, and
wherein the composition comprises a mixture of floating carrier material and non-floating carrier material, wherein the ratio of floating carrier material and non-floating carrier material lies in the range of 70%-30% and more preferably about 50%-50%.

20. The device according to claim 2, wherein the inner housing and/or the outer housing are arranged rotatably around the longitudinal axis and wherein, during use of the device, the vortex-like fluid flow path in the purification chamber is formed by the rotation of the inner housing and/or the outer housing.
